(19) United States
(12) Patent Application Publication
(10) Pub. No.: US 2012/0008693 A1
(43) Pub. Date: Jan. 12, 2012

(54) Substituting Embedded Text for Video Text Images

(75) Inventor: Kevin X. Yao, Cockeysville, MD (US)

(73) Assignee: EchoStar Technologies L.L.C., Englewood, CO (US)

(21) Appl. No.: 13/114,906

(22) Filed: May 24, 2011

Related U.S. Application Data
(60) Provisional application No. 61/362,612, filed on Jul. 8, 2010.

(51) Int. Cl. H04N 7/26

(52) U.S. Cl. 375/240.25; 375/240.29; 375/E07.027; 375/E07.189

(57) ABSTRACT

During encoding, blank frames may be substituted for text images in video content, encoding the blank frames instead of the text images. The text images may be any kind of text images such as opening credits, ending credits, and so on. The selection of text images to substitute may be performed by optical character recognition, user selection and so on. The text associated with the text images may be embedded in the encoded video. If the text is already embedded, an indicator of the location may be added. If not, the text may be derived from the text image using optical character recognition and then embedded. When decoded, the encoded video may be analyzed to determine whether blank frames were substituted for text images. Embedded text associated with the text images may then be located, obtained, and added to the decoded video. Thus, the original text images are essentially reconstructed.

### RELATED APPLICATIONS

The application claims priority under 35 U.S.C. §119(e) to U.S. Provisional Application Ser. No. 61/362,612, filed Jul. 8, 2010. which is herein incorporated by reference in its entirety.

### FIELD OF THE INVENTION

This disclosure relates generally to encoding and decoding of video, and more specifically to reducing the bitrate used to encode video by skipping video frames where only text appears and reconstructing the skipped frames utilizing text embedded in the video.

### SUMMARY

The present disclosure discusses systems, methods, and apparatuses for substituting blank frames for text images in video content. During encoding, blank frames may be encoded instead of actual text images in video content. Indicators may be added that indicate that the blank frames are encoded instead of the text images. The text images may be any kind of text images such as opening credits, ending credits, and so on. The text associated with the text images may be embedded in the encoded video. When the encoded video is decoded, it may be analyzed to determine whether blank frames were substituted for text images. Text embedded in the encoded video that is associated with the text images may then be located, obtained, and added to the decoded video. Thus, the original text images are essentially reconstructed. This enables a reduction of the bitrate required for the encoded video. As such, bitrate can be conserved for encoding more complex portions of the video content and the overall quality of the decoded video content may be improved over encoding techniques that do not perform this substitution.

In various implementations, the text images in the video content to be replaced with blank frames may be selected automatically, such as by computer program that detects text images in video content. In such a case, the computer program may also include optical character recognition capabilities and may capture the text in the images utilizing such technology. However, in various other implementations, the video content may be marked in response to user input and blank frames may be encoded instead of text images based on the marked portions of the video content. In such instances, text to embed in the encoded video may be received from a user transcribing text associated with the text images.

In some implementations, text associated with the text images in the video content may be embedded in the encoded video signal as part of substituting blank frames for the text images. However, in other implementations, the video content may be analyzed to determine if text associated with the images is already embedded in the video content. In such a case, the text may be embedded if the analysis determines that the text is not already present but not if the text is already present. If the text is embedded because the analysis determines that the text is not already present, the text may be derived by performing optical character recognition on the text images. If the text is not embedded because the analysis determines that the text is already present, indicators may be added that specify the location of the already embedded text.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for substituting embedded text for video text images;

FIG. 2 is a flow chart illustrating a method of encoding video by substituting embedded text for video text images that may be performed by the system of FIG. 1; and

FIG. 3 is a flow chart illustrating a method of decoding video that has been encoded by substituting embedded text for video text images that may be performed by the system of FIG. 1.

### DETAILED DESCRIPTION OF THE EMBODIMENTS

The description that follows includes sample systems, methods, and computer program products that embody various elements of the present disclosure. However, it should be understood that the described disclosure may be practiced in a variety of forms in addition to those described herein.

In some video encoding/decoding systems (such as multiple channel variable bitrate environments, average bit rate video on demand environments), the bitrate (or amount of output data per unit of time) utilized for encoding different portions of video for transmission may be varied. For example, a higher bitrate (and therefore more storage space and/or corresponding transmission media bandwidth) may be allocated to more complex portions of video while a lower bitrate (less space and/or transmission media bandwidth) may be allocated to less complex portions. An average bitrate for the encoded video as a whole may be produced by calculating the average of these rates. However, in such video encoding/decoding systems, the more bitrate that is allocated to a particular portion of video, the less bitrate is available to be allocated to another portion. Thus, the quality of a video encoded by such a system may depend on whether enough bitrate is available to encode the various portions of the video.

Many videos includes scenes that are mainly text displayed on a background of some kind. For example, many movies or television programs include opening and/or ending credits that are primarily text. By way of another example, video of classroom lectures, other kinds of presentations, and so on often include scenes displaying text on a whiteboard, blackboard, and so on. Encoding video images of the text in such scenes essentially wastes bits as encoding video images of text requires more bits than simply representing text in a text file. Further, encoding such video images of text consumes bitrate that could otherwise be utilized to encode more complex portions of video, such as car chase scenes and so on.

The present disclosure discloses systems, methods, and apparatuses for video encoding and decoding where blank frames may be encoded instead of encoding actual text images in video content. The text associated with the text images may be embedded in the encoded video. When the encoded video is decoded, the encoded video may be analyzed to determine whether blank frames were encoded instead of an associated text images. Text embedded in the encoded video that is associated with the text images may then be located, obtained, and added to the decoded video, essentially reconstructing the original text images. Thus, the bitrate required for encoded video is reduced and such bitrate can be conserved for encoding more complex portions of the video content, improving the overall quality of the decoded video content.

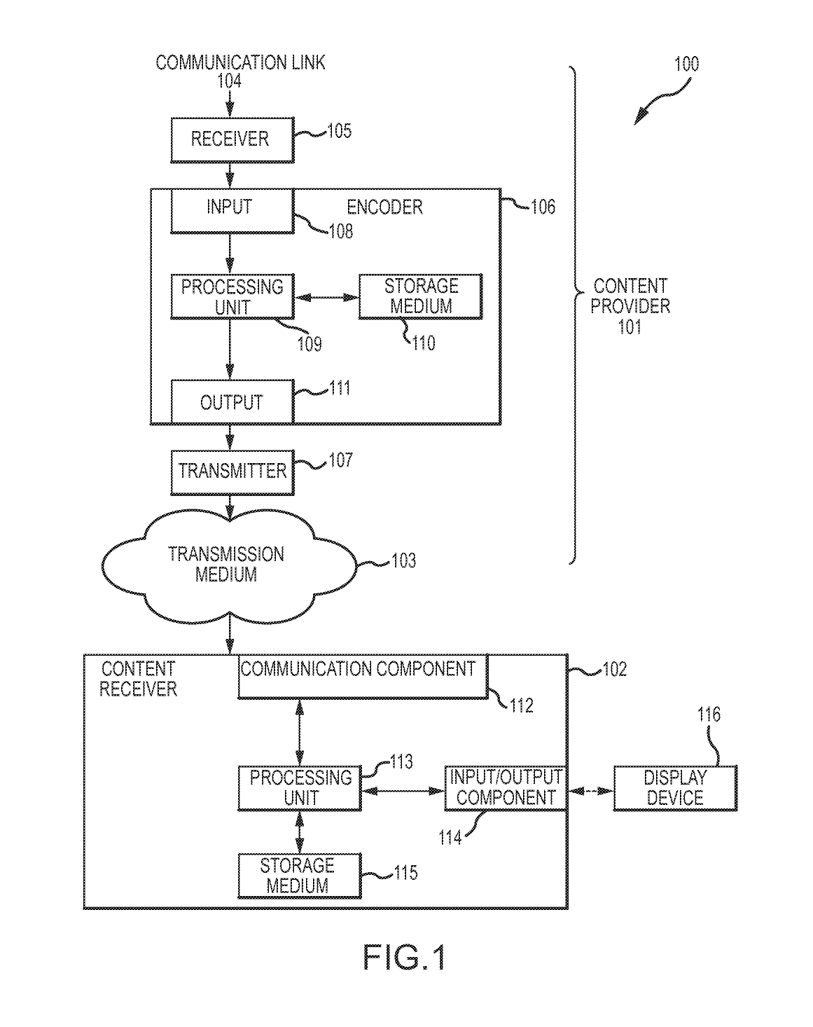

FIG. 1 is a block diagram illustrating a system 100 for substituting embedded text for video text images. The system 100 includes a content provider 101 and a content receiver 102. The content provider may provide content to the content receiver via a transmission medium utilizing a transmitter 107. The transmission medium may include any kind of transmission medium (wired, wireless, and so on) such as satellite, coaxial, fiber optic, the Internet, and so on. The content may include television programming, video on demand, audio programming, and so on. The content provider may also encode video, audio, and so on utilizing the encoder 106. The encoder 106 may encode video utilizing one or more video encoding algorithms, such as one or more varieties of MPEG encoding. The video, audio, and so on encoded by the content provider may be part of the content that the content provider may provide to the content receiver.

Although the encoder 106 is illustrated as a single device, it is understood that the content provider 101 may utilize multiple encoding devices to encode various content that may be provided to the content receiver. As illustrated, the encoder may include one or more processing units 109, a storage medium 110 (which may be any non-transitory machine-readable storage medium), and an output component 111. The encoder may also include an input 108 for receiving content to encode obtained from a communication link (such as a satellite communication link, a coaxial communication link, a wireless communication link, an Internet link, and so on) via a receiver 105. In some implementations, the encoder may encode content (such as video, audio, and so on) received by the input and store such encoded content in the storage medium and/or provide the encoded content via the output. In other implementations, the encoder the encoder may encode content stored in the storage medium and provide the encoded content via the output store and/or the encoded content in the storage medium.

The content receiver 102 may be any device, such a television receiver, a set top box, a cable box, a computer, a digital video recorder, and so on, that processes content provided by the content provider 101. In some implementations, the content receiver may process content for display on an associated display device 116 (such as one or more televisions, speakers, computer monitors, and so on). The content receiver 102 may include one or more processing units 113, a storage medium 115 (which may be any non-transitory machine-readable storage medium), a communication component 112, and one or more input/output components 114. The one or more processing units may execute software instructions stored in the storage medium to receive content provided by the content provider via the communication component, process such content (such as by decoding encoded video, encoded audio, and so on), and/or display processed content on the associated display device via the input/output component.

In one or more embodiments, the encoder 106 may obtain video content to encode. In some implementations, portions of the video content obtained by the encoder may already be marked as images of text. In other implementations, the encoder may mark portions of the video content as images of text. In various implementations, the portions may be marked in response to input received from a user. In various other implementations, the portions may be marked by a program that analyzes the video content and determines when text images are present. As part of marking the content, text from the text image may also be generated that may be embedded in the video content. The text to embed may be received from a user transcribing the text present in the text image, generated by an optical character recognition program in analyzing the text image, and so on. When the encoder encounters a marked portion while encoding the video content, the encoder may encode a blank frame (or a black frame) instead of encoding the actual text image. When the encoder encodes a blank frame instead of a text image, the encoder may mark the encoded video to indicate that a text image has been replaced by a blank frame, such as by setting one or more indicator bits, and may embed text associated with the text image in the video file (such as in a vertical blanking interval, a captioning field, and so on). Marking the encoded video to indicate that a text image has been replaced by a blank frame may also include marking the encoded video to indicate where the associated embedded text can be located, such as setting one or more location bits. In some implementations, the content provider 101 may then provide the encoded video to the content receiver 102. In other implementations, the content provider may provide video to the content receiver during the encoding process as it is encoded.

In various implementations, when the encoder 106 encodes a blank image instead of encoding the actual text image, the encoder may determine whether text associated with the text image is already embedded in the video content, such as in captioning data present in a captioning field. If the encoder determines that associated text is already embedded in the video content, the encoder may avoid duplication and not embed the associated text. In such cases, the encoder may mark the encoded video with the location where the embedded text is already present. However, if the encoder determines that associated text is not already embedded in the video content, the encoder embed the text the video file.

In various embodiments, the content receiver 102 may process encoded video received from the content provider 101 to reinsert embedded text for one or more blank frames that were encoded instead of an associated text image in video content. The content receiver may process the encoded video upon receipt from the content provider, while the encoded video is stored in the storage medium 115, and/or when the content receiver decodes the encoded video for display on the associated display device 116. The content receiver may analyze the encoded video while decoding to determine whether one or more blank frames were encoded instead of an associated text image in encoded video. The content receiver may make this determination based on the presence or absence of one or more indicator bits. When the content receiver determines one or more blank frames were encoded instead of an associated text image, the content receiver may locate and obtain the associated text embedded in the encoded video. In some implementations, the content receiver may locate the associated text by analyzing a location specified in one or more locator bits. In other implementations, the content receiver may locate the associated text by checking a default location whenever the content receiver determines one or more blank frames were encoded, such as a captioning field. After the content receiver locates the associated text, the content receiver may obtain the associated text from a vertical blanking interval, a captioning field, and so on. The content receiver may then add the obtained text to the decoded video, essentially reconstructing the original text image.

Although the system 100 is shown and described above in the context of the content provider 101 providing a single stream of content to the content receiver 102 via the transmitter 107 and transmission medium 103, it is understood that other configurations are possible without departing from the scope of the present disclosure. For example, the content provider may multiplex multiple streams of content and provide the multiplexed content to the content receiver. The content receiver may then demultiplex and select one or more streams of the content. Additionally, the content provider may encrypt content, scramble content, and so on before providing the content via the transmitter. In such cases, upon receipt of content the content receiver may appropriately decrypt received content, descramble received content, and so on. Further, although the content provider is shown and described above as including the communication link 104, the receiver 105, the encoder 106, and the transmitter, the content provider may include other components for providing content and performing other functions without departing from the scope of the present disclosure. For example, the content provider may include one or more programming sources, storage networks, broadcast centers, head end components, and so on. Additionally, rather than just a single communication link, receiver, encoder, transmitter, and so on, the content provider may include multiple such components which may be arranged in a variety of configurations without departing from the scope of the present disclosure.

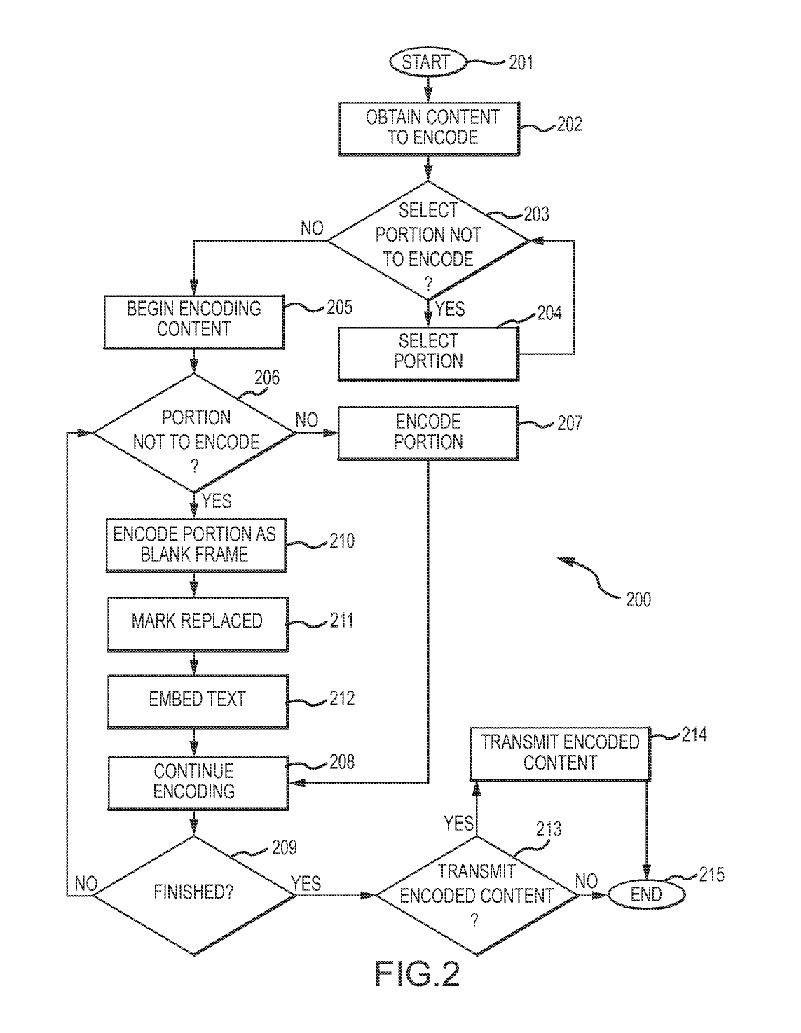

FIG. 2 illustrates a method 200 of encoding video by substituting embedded text for video text images that may be performed by the encoder 106. The flow begins at block 201 and the flow proceeds to block 202 where the encoder obtains the video content to encode before the flow proceeds to block 203. At block 203, the encoder determines whether to select a portion of the video content not to encode. If the encoder determines to select a portion of the video content not to encode, the flow proceeds to block 204 where the encoder selects a portion of the video content not to encode. The flow then returns to block 203. If the encoder does not determine to select a portion of the video content not to encode, the flow proceeds to block 205.

At block 205, the encoder 106 begins encoding the video content and the flow proceeds to block 206. At block 206, the encoder determines whether the current portion is selected to not be encoded. If the current portion is to be encoded, the flow proceeds to block 207 where the encoder encodes the portion. The flow then proceeds to block 208 where the encoder continues encoding the video content.

However, at block 206, if the encoder 106 determines that the current portion is not to be encoded, the flow proceeds to block 210. At block 210, the encoder encodes the current portion as a blank (or black) frame. The flow then proceeds to block 211 where the encoder marks the encoded blank frame as having been replaced. Next, the flow proceeds to block 212 where the encoder embeds text associated with the current portion in the encoded video. The flow then proceeds to block 208 where the where the encoder continues encoding the video content.

The flow next proceeds to block 209 where the encoder 106 determines whether encoding of the video content is finished. If the encoder is not finished encoding the video content, the flow returns to block 206. However, if the encoder is finished encoding the video content, the flow proceeds to block 213.

At block 213, the encoder 106 determines whether to transmit the encoded video. If the encoder determines to transmit, the flow proceeds to block 214 where the encoder transmits the encoded video before the flow proceeds to block 215 and ends. However, if the encoder determines at block 213 not to transmit the encoded video, the flow proceeds directly to block 215 and ends.

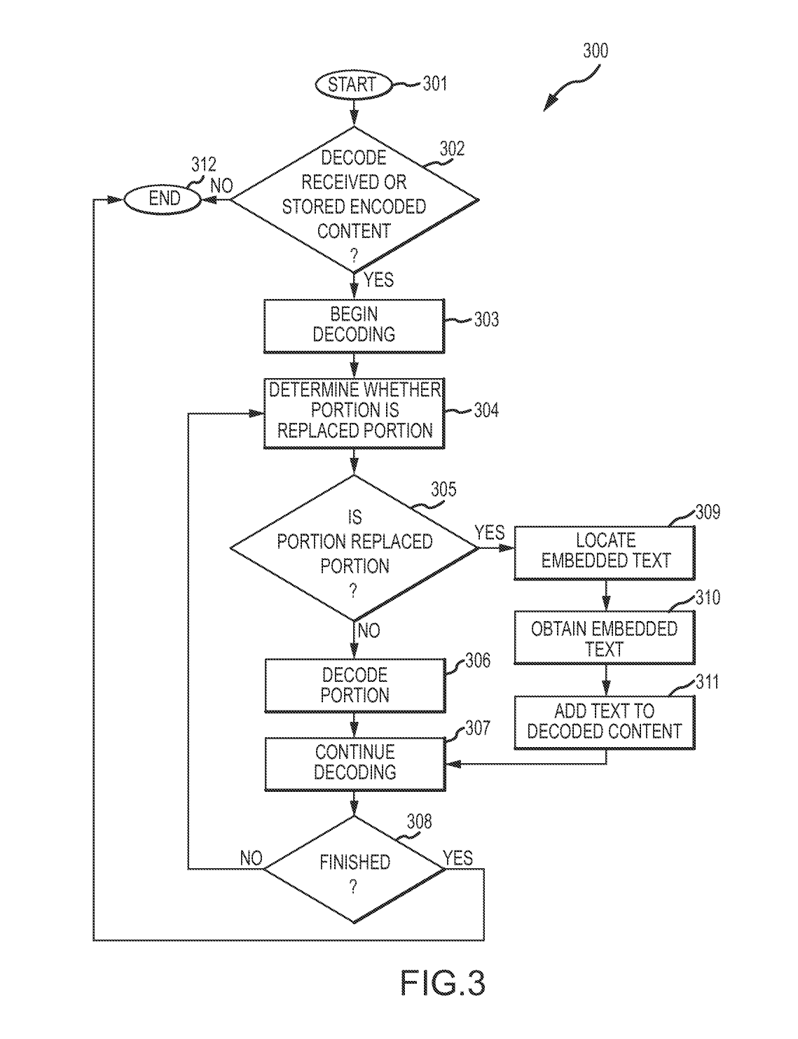

FIG. 3 illustrates a method 300 of decoding video that has been encoded by substituting embedded text for video text images that may be performed by the content receiver 102. The flow begins at block 301 where the content receiver determines whether to decode received and/or stored encoded video. The encoded video may be encoded according to the method of FIG. 2. If the content receiver determines not to decode received and/or stored encoded video, the flow proceeds to block 312 and ends. However, if the content receiver determines to decode received and/or stored encoded video, the flow proceeds to block 303 where the content receiver begins decoding the encoded video. The flow them proceeds to block 304.

At block 304, the content receiver 102 determines whether the current portion is a portion that was replaced with a blank (or black) frame when it was encoded. If the current portion is not a replaced portion, the flow proceeds to block 306 where the content receiver decodes the current portion. The flow then proceeds to block 307 where the content receiver continues decoding the encoded video. However, if the current portion is a replaced portion, the flow proceeds to block 309.

At block 309, the content receiver 102 locates the text embedded in the encoded video that is associated with the blank frame of the current portion. The flow then proceeds to block 310 where the content receiver obtains the embedded text. Next, the flow proceeds to block 311 where the content receiver adds the obtained text to the decoded video content. The flow then proceeds to block 307 where the content receiver continues decoding the encoded video.

From block 307, the flow proceeds to block 308 where the content receiver 102 determines whether if the content receiver is finished decoding the encoded video. If the content receiver is not finished decoding the encoded video, the flow returns to block 304. However, if the content receiver is finished decoding the encoded video, the flow proceeds to block 312 and ends.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a: magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A method for substituting embedded text for video text images, the method comprising:
selecting, utilizing at least one processing unit, at least one portion of video content that includes at least one text image; and
encoding the video content, utilizing the at least one processing unit, by encoding at least one blank frame rather than the at least one portion of video content.

2. The method of claim 1, further comprising:
determining, utilizing the at least one processing unit, that text corresponding to the at least one text image is not already embedded in the video content; and
embedding the text in the encoded video content.

3. The method of claim 2, wherein said operation of embedding the text in the encoded video content further comprises deriving the text from the at least one text image utilizing optical character recognition.

4. The method of claim 1, further comprising:
determining, utilizing the at least one processing unit, that text corresponding to the at least one text image is already embedded in the video content; and
incorporating, utilizing the at least one processing unit, at least one indicator into the encoded video content that specifies at least one location of the text embedded in the encoded video content.

5. The method of claim 1, further comprising incorporating, utilizing the at least one processing unit, at least one indicator that specifies that the at least one blank frame is encoded rather than the at least one portion of video content.

6. The method of claim 1, wherein said operation of selecting, utilizing at least one processing unit, at least one portion of video content that includes at least one text image further comprises selecting the at least one portion of video content that includes the at least one text image utilizing optical character recognition.

7. The method of claim 1, wherein said operation of selecting, utilizing at least one processing unit, at least one portion of video content that includes at least one text image further comprises selecting the at least one portion of video content that includes the at least one text image based on at least one received user input.

8. A method for substituting embedded text for video text images, the method comprising:
decoding encoded video content utilizing at least one processing unit;
determining, utilizing the at least one processing unit, that at least one frame of the video content is a blank frame encoded instead of at least one portion of video content that includes at least one text image; and
adding text to the decoded video content utilizing the at least one processing unit, wherein the text is obtained from embedded text in the encoded video content and the text corresponds to the at least one text image.

9. The method of claim 8, wherein said operation of adding text to the decoded video content utilizing the at least one processing unit further comprises obtaining the text from the encoded video content utilizing at least one indicator associated with the at least one blank frame that indicates at least one location of the text embedded in the encoded video content.

10. A system for substituting embedded text for video text images, comprising:
at least one processing unit that encodes video content, the video content including at least one portion that includes at least one text image; and
at least one output component that provides the encoded video content;
wherein the at least one processing unit selects the at least one portion that includes the at least one text image and encodes at least one blank frame instead of the at least one portion.

11. The system of claim 10, wherein the at least one processing unit selects the at least one portion that includes the at least one text image utilizing optical character recognition.

12. The system of claim 10, further comprising at least one input component wherein the at least one processing unit selects the at least one portion that includes the at least one text image based on at least one user input received via the at least one input component.

13. The system of claim 10, wherein the at least one processing unit determines that text corresponding to the at least one text image is already embedded in the video content and incorporates at least one indicator into the encoded video content that specifies at least one location of the text embedded in the encoded video content.

14. The system of claim 10, wherein the at least one processing unit incorporates at least one indicator that specifies that the at least one blank frame is encoded rather than the at least one portion.

15. The system of claim 10, wherein the at least one processing unit determines that text corresponding to the at least one text image is not already embedded in the video content and embeds the text in the encoded video content.

16. The system of claim 15, wherein the at least one processing unit derives the text to embed in the encoded video content by performing optical character recognition on the at least one text image.

17. The system of claim 10, further comprising a content receiver, comprising:
at least one communication component that receives the encoded video content from the at least one output component; and
at least one processing unit that decodes the encoded video content;
wherein the at least one processing unit detects the at least one blank frame, obtains the embedded text, and adds the obtained text to the decoded video content.

18. The system of claim 17, wherein the at least one processing unit obtains the embedded text from the encoded video content utilizing at least one indicator associated with the at least one blank frame that indicates at least one location of the embedded text in the encoded video content.

19. A content receiver, comprising:
at least one communication component that receives receive encoded video content, wherein the encoded video content includes embedded text and at least one blank frame encoded rather than at least one text image included in at least one portion of video content, wherein the embedded text corresponds to the at least one text image; and
at least one processing unit, communicably coupled to the at least one communication component, that decodes the encoded video content;
wherein the at least one processing unit identifies the at least one blank frame in the encoded video content, obtains the embedded text from the encoded video content, and add the obtained text to the decoded video content.

20. The content receiver of claim 19, wherein the at least one processing unit obtains the embedded text from the encoded video content utilizing at least one indicator associated with the at least one blank frame that indicates at least one location of the embedded text in the encoded video content.
